(19) United States
(12) Patent Application Publication
(10) Pub. No.: US 2013/0297490 A1
(43) Pub. Date: Nov. 7, 2013

(54) METHODS AND SYSTEMS FOR ROUTING AND SETTLING PAYMENT TRANSACTIONS ELECTRONICALLY

(71) Applicants: Deborah D. McWhinney, New York, NY (US); Julia C. Pukas, Hoboken, NJ (US); Kevin Tissot, Armonk, NY (US); Guy B. Sereff, Franklin, TN (US); Cecilia Leung, Millburn, NJ (US); Julie Monaco, New York, NY (US); David Strong, Millington, NJ (US); Craig Hansen, Dell Rapids, SD (US)

(72) Inventors: Deborah D. McWhinney, New York, NY (US); Julia C. Pukas, Hoboken, NJ (US); Kevin Tissot, Armonk, NY (US); Guy B. Sereff, Franklin, TN (US); Cecilia Leung, Millburn, NJ (US); Julie Monaco, New York, NY (US); David Strong, Millington, NJ (US); Craig Hansen, Dell Rapids, SD (US)

(73) Assignee: Citigroup Technology, Inc., New York, NY (US)

(21) Appl. No.: 13/462,999

(22) Filed: May 3, 2012

(51) Int. Cl. G06Q 20/22

(52) U.S. Cl. 705/39

(57) ABSTRACT

Methods and systems for routing payment transactions electronically for multinational vendors in a transnational business environment in which an integrated payments platform processor is used in receiving payment transactions related to a plurality of different countries by a financial institution for online purchases. Each payment transaction is interrogated, using the integrated payments platform processor, to identify the payment transaction as an internal type of transaction or an external type of transaction and a country to which the payment transaction relates. Internal types of transactions are routed to an internal transaction processing path and external types of transactions to an external processing path, and the financial institution may arrange settlement of each payment transaction likewise using the processor.

### FIELD OF THE INVENTION

The present invention relates generally to the field of electronic payments, and more particularly to methods and systems for routing and settling payment transactions electronically for vendors, such as multinational vendors.

### BACKGROUND OF THE INVENTION

Large multinational companies which wish to grow their business via online services, such as via the Internet, have in the past relied primarily on card associations, such as VISA® and MASTERCARD®. In some cases, such companies have also relied on aggregators, such as PAYPAL®, for access into given markets. In the past, such companies were able to gain remarkable growth in countries, such as the United States, where credit and debit card penetration is very high. However, as these companies began to look beyond the borders of countries, such as the United States, they ran into a number of business problems.

Even in developed countries, there are actually very few credit and/or debit cardholders. For example, in Germany only about 22% of the population has a credit card. In India, with a population of about 1.2 billion people, there are about 220 million checking accounts but only about 22 million credit cardholders. The way business is done in India today requires all companies that seek to become, for example, large providers of software or digital goods to pursue essentially the same 22 million cardholders at the exclusion of the 220 million checking account customers. The same is true around the world, for example, in countries such as Mexico and Brazil and throughout Europe. Thus, the first business problem can be characterized by limited market penetration because of an inability to reach a significant number of potential customers by such companies.

Secondly, in order to roll out internationally in those countries, it is necessary for such companies to enter numerous contracts with many different local firms. Typically, it may be necessary for a company, such as MICROSOFT® or APPLE® to enter contracts with a minimum of four or five local firms or up to a dozen or more of local firms to assist them in getting into markets in countries outside the United States. Typically, each company must enter individual agreements by engaging the services of various service providers to go into such countries and contract with each of multiple individual local banks in order to gain access to customers in particular countries. It would not be unusual for one of such companies to end up with agreements with ten to fifteen different firms, such as local banks, whose reputations are unknown outside the local environs. The entire process is extremely cumbersome, expensive, and time consuming. Moreover, in addition to the inconvenience and expense, doing business with such firms may carry a certain degree of risk.

Thirdly, using many different firms in each country requires that transactions and receivables from all of those different firms in each country must be aggregated and reconciled. In order to accomplish such aggregation and reconciliation, it is necessary for a company, such as MICROSOFT® or APPLE® to employ staff and experts who are knowledgeable about how each different local firm may present data, about what local terminology may be used in presenting data, and about what local accounting and audit standards and local banking regulations may be employed.

There is a current need for a payment access, clearing and settlement system that enables multinational or multiregional companies to expand their businesses in countries outside the United States beyond current debit or credit cardholders and without the necessity of relying on agreements with numerous local service providers and banks

### SUMMARY OF THE INVENTION

Embodiments of the invention employ computer hardware and software including, without limitation, one or more processors coupled to memory and non-transitory computer-readable storage media with one or more executable programs stored thereon which instruct the processors to perform the methods and systems for routing, settling and clearing transactions electronically described herein.

Embodiments of the invention provide methods and systems for routing and settling payment transactions electronically for multinational vendors in a transnational business environment in which an integrated payments platform processor may be used in receiving payment transactions related to a plurality of different countries by a financial institution for online purchases by purchasers from vendors. Each payment transaction may be interrogated, using the integrated payments platform processor, to identify the payment transaction as an internal type of transaction or an external type of transaction and a country to which the payment transaction relates. Using the processor, internal types of transactions may be routed to an internal transaction processing path and external types of transactions may be routed to an external processing path, and each payment transaction may be settled by the financial institution.

According to an aspect of embodiments of the invention, the payment transactions may be received via a network from purchasers' devices. The payment transactions received via the network from purchasers' devices may be entered on purchasers' devices in response to prompts. In another aspect, receiving payment transactions may involve, for example, receiving payment transactions consisting at least in part of transaction card payment transactions, automated clearinghouse payment transactions, and direct debit payment transactions. In a further aspect, receiving payment transactions consisting at least on part of transaction card payment transactions may involve, for example, receiving transaction card payment transactions consisting at least in part of card association transaction card payment transactions and at least in part of regional transaction card payment transactions. In an additional aspect, receiving payment transactions may involve, for example, receiving payment transactions consisting at least in part of convenience store payment transactions or net banking payment transactions.

According to further aspect of embodiments of the invention, interrogating each payment transaction may involve, for example, interrogating each payment transaction using computer logic programming of the integrated payments platform processor that recognizes to which one of a plurality of different countries each payment transaction relates. In another aspect, interrogating each payment transaction may involve, for example, interrogating each payment transaction using computer logic programming of the integrated payments platform processor that identifies a type of each payment transaction and recognizes what types of payment transactions to expect in each one of the plurality of different countries. In an additional aspect, interrogating each payment transaction may involve interrogating each payment transaction using computer logic programming of the integrated payments platform processor that recognizes which payment transactions are processable internally by the financial institution.

In another aspect of embodiments of the invention, routing internal types of transactions to an internal transaction processing path may involve routing internal types of transactions to an internal payment transaction processing path in which an internal type transaction is processed at least in part by an internal transfer of funds by the financial institution from an account of a purchaser to an account of a vendor. In still another aspect, routing internal types of transactions to an internal transaction processing path may involve, for example, routing at least some internal types of transactions to an internal transaction processing path in which the financial institution functions as a merchant acquirer for the vendor.

In a further aspect of embodiments of the invention, routing external types of transactions to an external transaction processing path may involve routing external types of transactions to an external processing path consisting of either a regional processing path or an in-country processing path. In another aspect, routing external types of transactions to a regional processing path may involve routing external types of transactions to a regional central bank, a regional financial institution partner, or a regional card processing association for processing. In another aspect, routing external types of transactions to an in-country processing path may involve routing external types of transactions to either an in-country central bank, a local financial institution partner, or a local card processing association for processing. In additional aspects, routing external types of transactions to an external transaction processing path may involve routing at least some external types of transactions to an external processing path for a country to which the external payment transactions relates other than a country in which the financial institution is headquartered.

According to still further aspects of embodiments of the invention, settling each payment transaction by the financial institution may involve settling each internal type transaction by debiting a purchaser's account with the financial institution and crediting a vendor's account with the financial institution. In other aspects, settling each payment transaction by the financial institution may involve settling at least some external type transactions by the financial institution via an external processing path for a country to which the external type transaction relates other than a country in which the financial institution is headquartered. In still other aspects, settling at least some external type transactions via an external processing path for a country to which the external transaction relates other than a country in which the financial institution is headquartered may involve receiving at least some purchasers' dropbox payments by the financial institution.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that illustrates an example of key components and the flow of information between key components of an integrated payments platform for embodiments of the invention;

FIG. 2 is a schematic diagram that illustrates an example of key components and the flow of information between key components in a payments servicing process for embodiments of the invention; and

FIG. 3 is a flow chart which illustrates an example of the process of routing and settling payment transactions electronically for multinational vendors in a transnational business environment for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Aspects of embodiments of the invention provide an integrated payment platform with presentment, clearing and settlement services, for example, for multinational and multiregional companies. The integrated payment platform for embodiments of the invention gives such companies a single window, via an application programming interface, into a single global financial institution with all of the required licenses in numerous countries throughout the world.

In addition, the integrated payment platform for embodiments of the invention provides access to clearance systems in an even larger number of countries worldwide. This feature eliminates the need for such multinational and multiregional companies to enter contracts with numerous different local firms in different countries, making it much easier to do business in those countries. Embodiments of the invention give such multinational and multiregional companies scalability and provide those companies with a much lower cost of doing business.

On the backend, embodiments of the invention afford such companies the benefit of all the facilities that the global financial institution provides, such as a global transaction receivables reporting and analysis system. This eliminates the need for such companies to build their own systems, such as their own management information systems, in order to bridge, for example, upwards of thirteen or fourteen firms with which they may presently be doing business.

In embodiments of the invention, the global financial institution has a footprint around the world in order to have access to card association transaction processing systems, such as VISA® and MASTERCARD® transaction processing systems, in various countries. In addition, according to embodiments of the invention, the global financial institution is a member of the banking community that gives it access to clearance systems in countries throughout the world. Further, in embodiments of the invention, the global financial institution has local sales forces and local implementation teams in such countries worldwide, which provides cost effectiveness. Also, embodiments of the invention provide a payment platform, for example, for multinational and multiregional companies, that is technologically sound, secure, and reliable.

Assume, for example, that a consumer located in a country outside the United States, such as India, wishes to make a purchase, such as a digital song, on a merchant's Internet website and download the song to the consumer's computing device, such as his or her personal computer. In order to pay for the purchase, the consumer may go to a landing page (e.g., a web page that appears in response to clicking on an advertisement) for the website. On the landing page, the consumer may be asked if he or she wishes to charge the purchase price to his or her credit card, such as a VISA® or MASTERCARD® credit card, which is the customary payment method for online purchases in the United States. The vendor may, in turn, send an advice to the consumer notifying the consumer that payment has been received and that the consumer may now download the purchased software.

A consumer in India who is not among the 22 million credit cardholders in India may wish instead to pay via automated clearinghouse (ACH) debit. In order to accomplish such payment, the consumer may notify his or her bank and authorize the online vendor to debit the consumer's account with the consumer's bank. Consequently, it may be necessary for the consumer's shopping cart on the vendor's website landing page to remain active for whatever period of time may be required for the authorization and debit to occur. That period of time may extend to two or more business days. Such authorization and debit process may involve, for example, the landing page notifying the vendor of the authorization, the vendor notifying the vendor's bank of the authorization, and the vendor's bank proceeding to debit the consumer's account based on the authorization. The vendor may also send an advice to the consumer notifying the consumer that payment has been received and that the consumer may now download the purchased software.

Assume, for another example, that the same consumer in India who is not a credit cardholder wishes to make a more expensive online purchase, such as computer software for the consumer's personal computer, which may cost the equivalent of hundreds of dollars. In such case, the consumer in India may notify the online software vendor, such as MICROSOFT®, that he or she wishes to pay the purchase price via a dropbox, which is a common payment method in India. The consumer may print out what is essentially a receipt and physically take the receipt, together with his or her payment, to a dropbox of the online vendor. Such drop boxes can be found, for example, on street corners in major cities throughout India. The consumer may then physically place the receipt and payment in the drop box. Thereafter, the vendor's bank receives and processes the payment and notifies the vendor. The vendor may likewise, in turn, send an advice to the consumer notifying the consumer that payment has been received and that the consumer may now download the purchased software.

In embodiments of the invention, the global financial institution, in cooperation, for example, with online vendors, such as MICROSOFT® and APPLE®, may study each of a number of countries worldwide to determine exactly how local people actually handle banking and payment of bills. In particular, the global financial institution may study how such people, who are not credit cardholders, handle such matters. Based upon such study, embodiments of the invention may involve, for example, construction by the global financial institution of payment types for each country that can be used by the entire population of each country.

Embodiments of the invention may provide, for example, a payment platform landing page that enables consumers in each country to pay for online purchases in a number of different ways that are commonly used by consumers in each country. Thus, the payment platform landing page for embodiments of the invention may enable consumers in each country to make payments in various ways commonly used by consumers in each country in addition to the payment methods typically used in the United States, such as credit card payments. Accordingly, embodiments of the invention provide a payment platform that enables online vendors, such as multinational and multiregional companies, to reach consumers in various countries throughout the world who were not previously reachable using conventional credit card type payment methods employed in the United States. It is to be understood that the orchestration of the landing page is up to the vendor and that the vendor has the flexibility to use the services provided by embodiments of the invention according to the vendor's process.

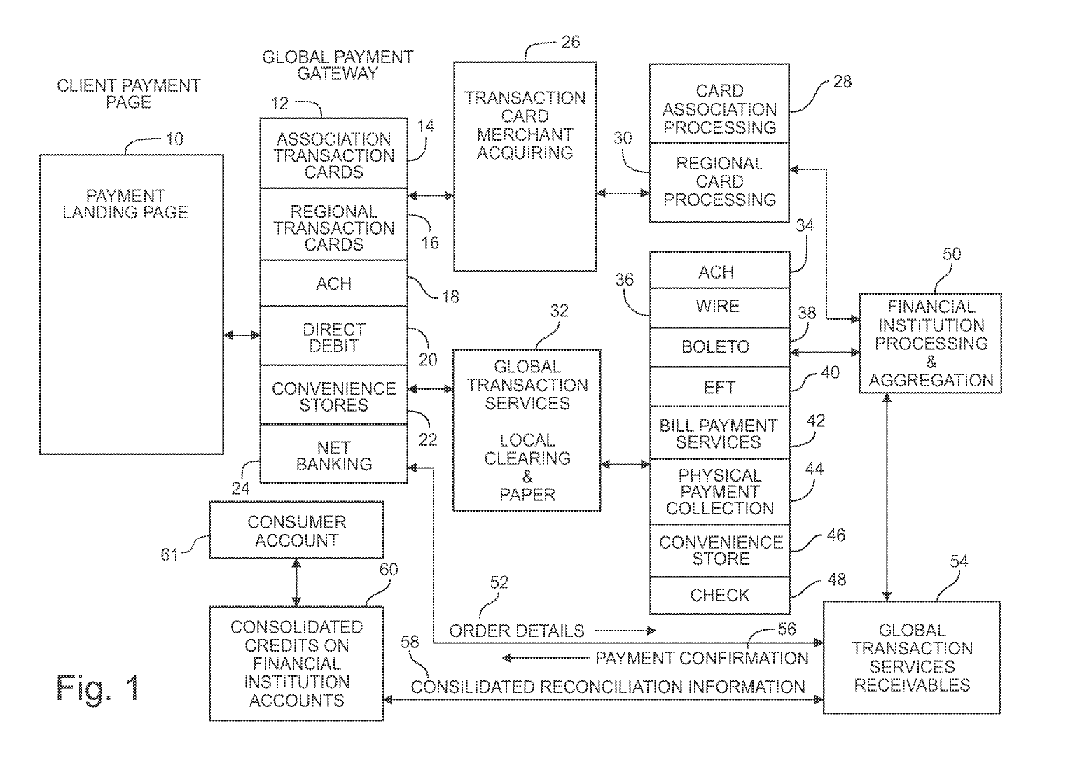

FIG. 1 is a schematic diagram that illustrates an example of key components and the flow of information between key components of an integrated payments platform for embodiments of the invention. Referring to FIG. 1, transaction information entered on a client's payment page, such as payment landing page 10, may be received via a global payment gateway 12. The types of transaction information received may include, for example, transaction card information, such as payment information related to card association transaction cards 14 or regional transaction cards 16, or non-transaction card information, such as payment information related to automated clearinghouse 18, direct debit 20, convenience stores 22, or net banking 24. The transaction card information may be routed, for example, for transaction card processing with the financial institution acting as merchant acquirer 26 for processing either internally by the financial institution or via a card association transaction card processing network 28 or a regional card processing network 30. The non-transaction card transaction information may be routed, for example, for local clearing and paper processing 32.

Referring further to FIG. 1, local clearing and paper processing 28 may include, for example, processing related to automated clearinghouse 34; wire transfer 36; ticket or boleto 38; electronic funds transfer 40; bill payment services 42; physical payment collection 44, such as drop box, lockbox, or post office; convenience store 46; or check 48. The transaction information may be further routed for financial institution processing and aggregation 50. In addition, order details 52 received via the global payment gateway 12 may be routed to the financial institution's receivables function 54. In turn, payment confirmation 56 may be sent from the receivables function 54 via the global payment gateway 12 to the payment landing page 10, consolidated reconciliation information 58 may be sent from the receivables function 54 to a consolidated credits and financial institution accounts function 60, and a consumer account 61 may be debited.

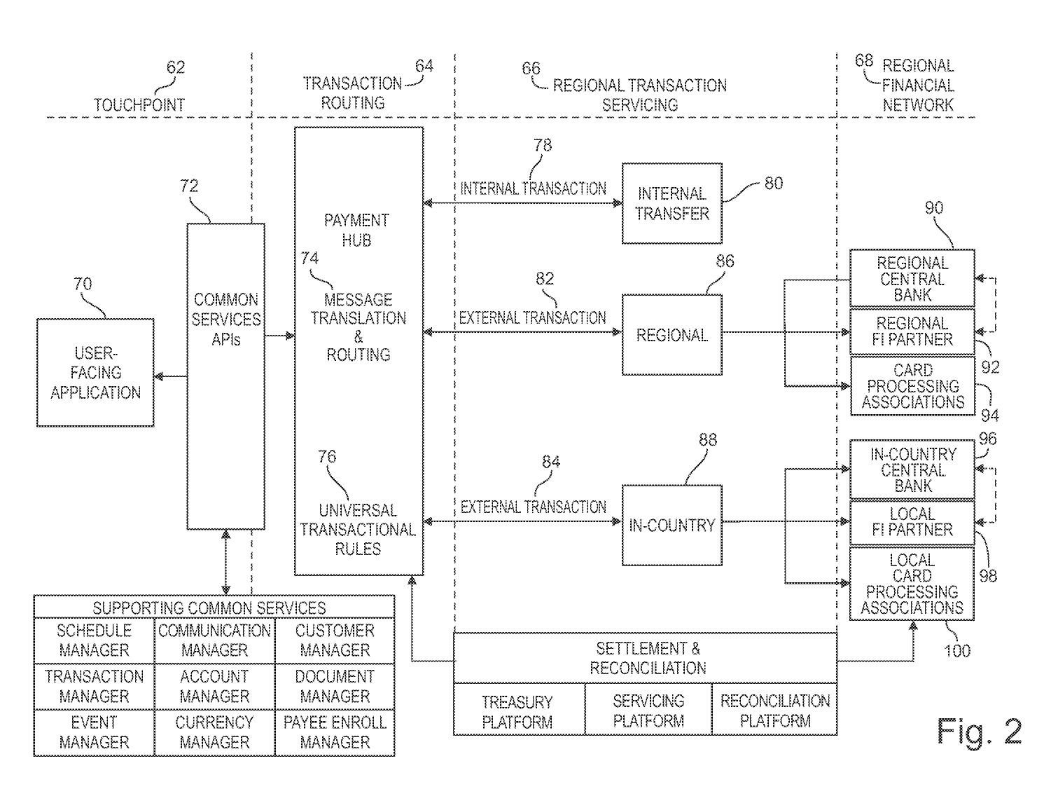

FIG. 2 is a schematic diagram that illustrates an example of key components and the flow of information between key components for transaction servicing for embodiments of the invention. Referring to FIG. 2, transaction servicing for embodiments of the invention may include, for example, touchpoint functions 62, transaction routing functions 64, transaction servicing functions 66, and regional financial servicing functions 68. The touchpoint functions 62 may include, for example, one or more user facing applications 70 and common services application programming interfaces 72, such as Web Services Description Language, Simple Object Access Protocol, and/or Java Message Service. The transaction routing functions 64 may include, for example, message translation and routing 74 and universal transaction rules 76.

Referring again to FIG. 2, transaction servicing 66 may include, for example, internal transfer processing 80, regional processing 86, and in-country processing 88. Internal transactions 78 may be routed, for example, to internal transfer processing 80. External transactions 82, 84 may be routed, for example, to regional processing 86 or to in-country processing 88. Regional processing 86 may include, for example, regional central bank processing 90, regional financial institution partner processing 92, or card association processing 94. In-country processing 88 may be routed, for example, to in-country central bank processing 96, local financial institution partner processing 98, or local card association processing 100.

Referring FIGS. 1 and 2, embodiments of the invention may employ, for example, a payment landing page 10 in communication with the integrated payment platform of the financial institution. Embodiments of the invention may provide a single interface 12 of the integrated payment platform into all of a financial institution's global transaction services within all countries that may be considered to be important to multinational or multiregional companies for reaching consumers within those countries. Further, embodiments of the invention may bring those services together with credit card-type merchant acquiring services 26, such as those associated with VISA® and MASTERCARD® transactions, and associated backend reporting 56, 58, 60.

Referring further to FIG. 1, embodiments of the invention may employ a client (e.g., a multinational or multiregional vendor) landing or checkout page 10 in connection with the client's website. The landing page 10 may be managed by the financial institution and white labeled (i.e., labeled by the client) or owned by the client. Thus, the client may control the landing page 10 and the financial institution may work with the client. A client may accept only certain types of payments for its products in transactions on its landing page 10. Depending, for example, on the different types of products and transactions offered by a particular client on its website, each client may accept different types of payments for its products on its landing page 10. Therefore, each landing page 10 may be different, similar to the variety of clients' products offered on their respective websites.

Embodiments of the invention provide a single consistent interface 12 for each client. Thus, instead of communicating with numerous different companies in each different country, each client may be able to communicate with only a single company, namely the global financial institution that provides an interface 12 in all countries. Referring further to FIGS. 1 and 2, using the routing function 64 of the integrated payment platform, all payment transactions may be interrogated to identify such transactions, for example, as an internally processable payment transaction 78 or a payment transaction requiring external processing 82, 84. As previously noted, internally processable payment transactions 78 may include, for example, transaction card payment transactions in which the global financial institution functions as a merchant acquirer 26. As also previously noted, payment transactions requiring external processing 82, 84 may include, for example, transactions requiring regional processing 86 and in-country processing 88.

In embodiments of the invention, the financial institution may function as a merchant acquirer 26 for each client in all card transaction processing, such as VISA®, MASTERCARD®, or DISCOVER® type transactions, locally in all countries. Embodiments of the invention also provide the single interface 12 online for local clearing transactions, such as automated clearinghouse (ACH) 34, wire 36, boletos or tickets 38, electronic funds transfer 40, bill payment services 42, or convenience store 46, as well as for paper transactions, such as physical payment collection 44 or check 48. In embodiments of the invention, computer logic of the interface 12 may identify a particular country to which a payment transaction may relate. For example, computer logic of the interface 12 for embodiments of the invention may identify a particular country, such as Denmark, Brazil, or Mexico, to which a local 88 or regional 86 debit transaction may relate.

It is to be noted that many local 88 or regional 86 debit processors in different countries do not currently process “card not present” transactions. In such “card not present” transactions, merchandise may be ordered by telephone, mail or online over the Internet, and the merchant must rely on the veracity of the person that presents card information to the merchant indirectly. Computer logic of the interface 12 for embodiments may identify, for example, a debit transaction related to a country in which the local or regional debit processors do not process “card not present” transactions. Such a transaction may be routed on the backend, for example, to another company, such as a card processor.

Computer logic of the interface 12 for embodiments of the invention may be programmed to know what types of transactions to expect in all countries for the landing page 10 for a particular client. For example, computer logic of interface 12 may be programmed to recognize which transactions the global financial institution can process internally 78. Further, the computer logic of the interface 12 may be programmed to know what to expect in transaction processing in various countries outside the United States, such as India, Australia, and Brazil. Thus, computer logic of the interface 12 may recognize to which country a particular transaction relates and may route the transaction to the appropriate destination and thereafter may likewise route the approval process appropriately. A transaction request may be rejected if the transaction request cannot be processed in a particular country, such as a payment type that is not available in the particular country.

In embodiments of the invention, all electronic transactions are interrogated by computer logic of the interface 12 and routed to an appropriate processing path. Offline or out-of-band channels may be prevalent in many countries that have payment schemes entirely different from the United States and that often involving cash payments. An example of such a payment scheme is one offered as a service by China Post. China is a country in which many consumers have neither a credit card nor a checking account. Assume, for example, that such a consumer in China wishes to purchase a video game from an online vendor. The Chinese consumer may go to the vendor's website and order the video game online. After placing the order online, the consumer may print out an invoice. The consumer may then physically deliver the invoice and cash for the online purchase to one of the offices of China Post, which in turn may transfer the funds for the purchase electronically to the online vendor. Computer logic of the interface 12 comprises an intelligent routing engine 74 that recognizes such a transaction and routes the transaction, for example, to China Post for physical payment collection processing 44.

Currently, most of the companies used outside the United States by online vendors do not have access into local payment gateways, which means such companies must still use other companies for that purpose. Further, outside the United States, offline or out-of-band channels are generally not available at all on existing website landing pages. With respect to card transactions for consumers in a country outside the United States, such as Mexico, it is necessary, first of all, for an online vendor to have business in Mexico. Second, it is necessary for such a vendor to seek out and make individual deals for card acquiring services in Mexico in order have its card transactions processed. The same is true in every country in which the vendor may want to do business. Thus, if the vendor wishes to do business in 57 countries, it would be necessary for the vendor to have 57 different sets of agreements (i.e., one in each country) in order to access the local banking system of each of the 57 countries. It can be done, but it is obviously a very cumbersome, time consuming and expensive process.

Online payment and local debit processing in countries outside the United States is even more difficult because, for example, of requirements of local rules and regulations. Again, such local debit processing can be arranged through multiple agreements with local middleman-type organizations on a country-by-country basis. However, arranging such local debit processing is even more cumbersome, time consuming and expensive than arranging local card transaction processing.

As previously mentioned, offline or out-of-band payment channels are generally not available on existing website landing pages. An example of such an out-of-band payment channel is BOLETO BANCARIO™ in Brazil. When BOLETO BANCARIO™ is chosen by a consumer as an online payment method, a pre-filled payment slip or boleto is presented in a popup window that can be printed off and taken to a bank to physically make the payment, or the consumer can use his or her online banking In order for a vendor to arrange that type of transaction processing outside the United States, it would be necessary to enter agreements with a company that does business in Brazil. It would also be necessary for the vendor to deal with a bank that likewise has business in Brazil. In other words, arranging that type of transaction processing would be a two-step process in which it would be necessary for the online vendor to enter an agreement with a local processor and also to enter an agreement with a local bank, because the payments are made at a local bank.

Embodiments of the invention provide an integrated payments platform for a global financial institution, such as a global bank, that allows an online vendor to simply tell the bank what type or types of payment processing the vendor wants and in which country or countries. Because the global financial institution is already in the banking system in most countries worldwide, the integrated payments platform for embodiments of the invention enables the global financial institution to route all transactions appropriately without engaging numerous local companies, such as multiple different processors in different countries, in multiple different agreements.

The integrated payments platform for embodiments of the invention may receive payment transactions at the interface 12, for example, from a client's website landing page 10. Such payments may include, for example, card association transaction card payments 14, regional transaction card payments 16, automated clearinghouse payments 18, debit direct payments 20, convenience store payments 22, net banking payments 24, or check draft. As such payment transactions are received, computer logic of interface 12 may interrogate each transaction and route the transaction for processing via a processing channel that is appropriate to the particular type of payment in the particular country to which the payment relates.

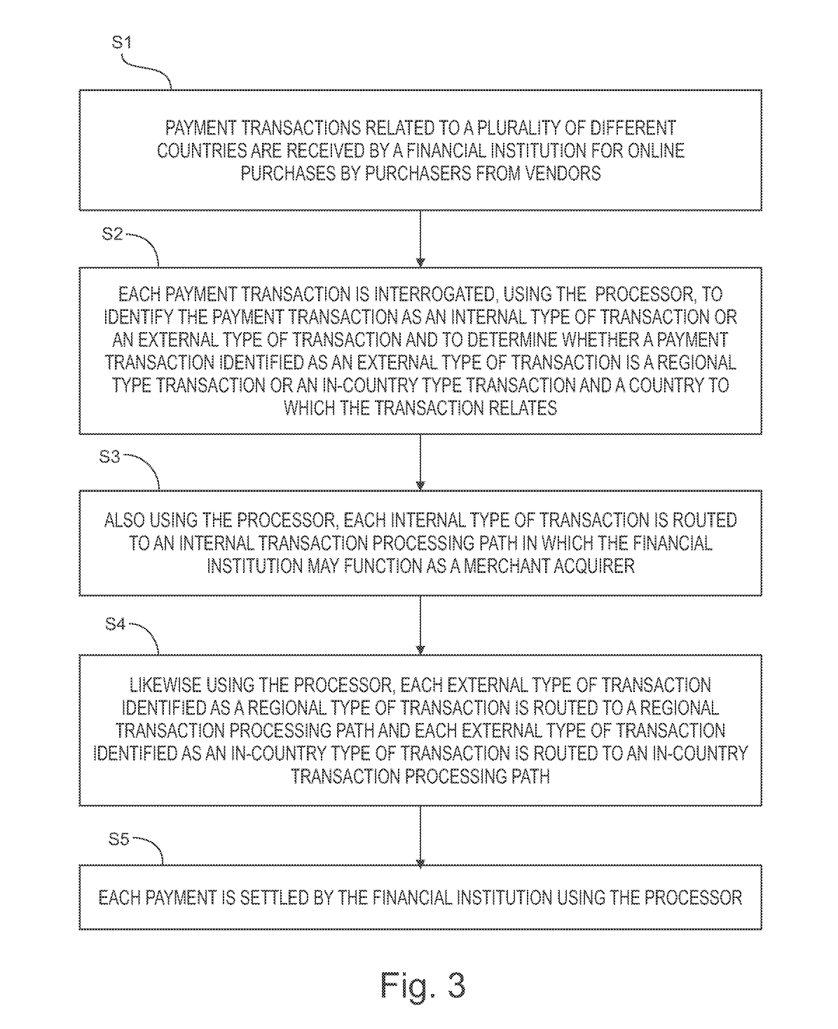

FIG. 3 is a flow chart which illustrates an example of the process of routing payment transactions electronically for multinational vendors in a transnational business environment for embodiments of the invention. Referring to FIG. 3, at S1, using a processor of the integrated payments platform, payment transactions related to a plurality of different countries are received by a financial institution for online purchases by purchasers from vendors. At S2, each payment transaction is interrogated, using the processor, to identify the payment transaction as an internal type of transaction 78 or an external type of transaction 82, 84 and to determine whether a payment transaction identified as an external type of transaction 82, 84 is a regional type transaction 86 or an in-country type transaction 88 and a country to which the transaction relates. At S3, also using the processor, each internal type of transaction is routed to an internal transaction processing path 80 in which the financial institution may function as a merchant acquirer 26. At S4, likewise using the processor, each external type of transaction identified as a regional type of transaction is routed to a regional transaction processing path and each external type of transaction identified as an in-country type of transaction is routed to an in-country transaction processing path. At S5, each payment is settled with the financial institution using the processor.

For example, a card transaction may be routed for internal processing 80 with the financial institution functioning as the merchant acquiring bank 26. In an external payment transaction 84 for in-country processing 88 in a country, such as China, a consumer may print off an invoice and deliver it with a physical cash payment 44 to China Post. China Post may, in turn, credit the vendor's account with the global financial institution. Thereupon, the vendor may issue an advice to the consumer that the payment has been credited and that the goods will be delivered. In embodiments of the invention, order details 52 may follow along with all transactions from the landing page 10 of a particular website, and thus may be reconciled in a reporting function.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

1. A method for routing and settling payment transactions electronically for multinational vendors in a transnational business environment, comprising:
receiving, using an integrated payments platform processor, payment transactions consisting of both transaction card payment transactions and non-transaction card payment transactions related to a plurality of different countries by a financial institution for online purchases by purchasers from vendors;
interrogating, using the processor, each payment transaction to identify the payment transaction as an internal type of transaction processed internally by the financial institution or an external type of transaction processed other than internally by the financial institution and a country to which the payment transaction relates;
routing, using the processor, internal types of transactions to an internal transaction processing path of the financial institution and external types of transactions to an external processing path other than the internal transaction processing path of the financial institution; and
arranging, using the processor, settlement of each payment transaction by the financial institution.

2. The method of claim 1, wherein receiving payment transactions further comprises receiving the payment transactions via a network from purchasers' devices.

3. The method of claim 1, wherein receiving payment transactions further comprises receiving payment transactions entered on purchasers' devices in response to prompts.

4. The method of claim 1, wherein receiving payment transactions further comprises receiving payment transactions consisting at least in part of transaction card payment transactions, automated clearinghouse payment transactions, and direct debit payment transactions

5. The method of claim 4, wherein receiving payment transactions consisting at least in part of transaction card payment transactions further comprises receiving transaction card payment transactions consisting at least in part of card association transaction card payment transactions and at least in part of regional transaction card payment transactions.

6. The method of claim 1, wherein receiving payment transactions further comprises receiving payment transactions consisting at least in part of convenience store payment transactions.

7. The method of claim 1, wherein receiving payment transactions further comprises receiving payment transactions consisting at least in part of net banking payment transactions.

8. The method of claim 1, wherein interrogating each payment transaction further comprises interrogating each payment transaction using computer logic programming of the integrated payments platform processor that recognizes to which one of a plurality of different countries each payment transaction relates.

9. The method of claim 8, wherein interrogating each payment transaction further comprises interrogating each payment transaction using computer logic programming of the integrated payments platform processor that identifies a type of each payment transaction and recognizes what types of payment transactions to expect in each one of the plurality of different countries.

10. The method of claim 1, wherein interrogating each payment transaction further comprises interrogating each payment transaction using computer logic programming of the integrated payments platform processor that recognizes which payment transactions are processable internally by the financial institution.

11. The method of claim 1, wherein routing internal types of transactions to an internal transaction processing path further comprises routing internal types of transactions to an internal payment transaction processing path in which an internal type transaction is processed at least in part by an internal transfer of funds by the financial institution from an account of a purchaser to an account of a vendor.

12. The method of claim 1, wherein routing internal types of transactions to an internal transaction processing path further comprises routing at least some internal types of transactions to an internal transaction processing path in which the financial institution functions as a merchant acquirer for the vendor.

13. The method of claim 1, wherein routing external types of transactions to an external transaction processing path further comprises routing external types of transaction to an external processing path consisting of one of a regional processing path and an in-country processing path.

14. The method of claim 13, wherein routing external types of transactions to a regional processing path further comprises routing external types of transactions to a one of a regional central bank, a regional financial institution partner, and a regional card processing association for processing.

15. The method of claim 13, wherein routing external types of transactions to a in-country processing path further comprises routing external types of transactions to a one of an in-country central bank, a local financial institution partner, and a local card processing association for processing.

16. The method of claim 1, wherein routing external types of transactions to an external transaction processing path further comprises routing at least some external types of transactions to an external processing path for a country to which the external types of transactions relate other than a country in which the financial institution is headquartered.

17. The method of claim 1, wherein arranging settlement of each payment transaction by the financial institution further comprises settling at least some internal type payment transactions by debiting a purchaser's account with the financial institution and crediting a vendor's account with the financial institution.

18. The method of claim 1, wherein arranging settlement of each payment transaction by the financial institution further comprises arranging settlement of at least some external types of transactions by the financial institution via an external processing path for a country to which the external type of transactions relate other than a country in which the financial institution is headquartered.

19. The method of claim 18, wherein arranging settlement of at least some external type of transactions via an external processing path for a country to which the external type of transactions relate other than a country in which the financial institution is headquartered further comprises receiving at least some purchasers' dropbox payments by the financial institution.

20. A machine for routing and settling payment transactions electronically for multinational vendors in a transnational business environment, comprising:
an integrated payments platform processor coupled to memory, wherein the processor is programmed for:
receiving payment transactions consisting of both transaction card payment transactions and non-transaction card payment transactions related to a plurality of different countries by a financial institution for online purchases by purchasers from vendors;
interrogating each payment transaction to identify the payment transaction as an internal type of transaction processed internally by the financial institution or an external type of transaction processed other than internally by the financial institution and a country to which the payment transaction relates;
routing internal types of transactions to an internal transaction processing path of the financial institution and external types of transactions to an external transaction processing path other than the internal transaction processing path of the financial institution; and
arranging settlement of each payment transaction by the financial institution.
